(19) United States
(12) Patent Application Publication
(10) Pub. No.: US 2014/0335882 A1
(43) Pub. Date: Nov. 13, 2014

(54) METHOD FOR CONFIGURING DUAL CONNECTIVITY

(71) Applicant: Electronics & Telecommunications Research Institute, Daejeon (KR)

(72) Inventors: Kyoung Seok LEE, Daejeon (KR); Seung Kwon BAEK, Daejeon (KR); Jung Sook BAE, Daejeon (KR); Jae Young AHN, Daejeon (KR)

(73) Assignee: Electronics & Telecommunications Research Institute, Daejeon (KR)

(21) Appl. No.: 14/273,092

(22) Filed: May 8, 2014

(30) Foreign Application Priority Data
May 10, 2013 (KR) 10-2013-0053357
Jul. 24, 2013 (KR) 10-2013-0087192
May 8, 2014 (KR) 10-2014-0054668

(51) Int. Cl. H04W 76/02

(52) U.S. Cl. CPC H04W 76/021
USPC 455/452.2

(57) ABSTRACT

Disclosed is a method for configuring dual connectivity. A method for configuring dual connectivity, performed in a base station, may comprise receiving measurement information about a neighbor cell of the terminal from the terminal; obtaining information for configuring dual connectivity from the terminal or the base station; determining whether to configure dual connectivity based on the measurement information and the information for configuring dual connectivity; and when the dual connectivity is to be configured, transmitting a message instructing to configure the dual connectivity to the terminal.

### CROSS-REFERENCE TO RELATED APPLICATIONS

This application claims priorities to Korean Patent Applications No. 10-2013-0053357 filed on May 10, 2013, No. 10-2013-0087192 filed on Jul. 24, 2013, and No. 10-2014-0054668 filed on May 8, 2014 in the Korean Intellectual Property Office (KIPO), the entire contents of which are hereby incorporated by reference.

### BACKGROUND

1. Field

Example embodiments of the present invention relate in general to a mobile communication technology, and more specifically, to a method of configuring dual connectivity for supporting mobility of a terminal.

2. Description of Related Art

Due to wide distribution of mobile terminals and tablet PCs and rapid advancement of mobile computing based on wireless internet technologies, innovative increase of wireless network capacity is being demanded.

Currently, the 4^{th} generation mobile communication system such as a Long Term Evolution (LTE) system has been commercialized world-widely so as to provide higher data transmission rates to users as compared to the 3^{rd} generation mobile communication system. However, it is difficult to satisfy explosively increasing mobile data traffic even by using the 4^{th} generation mobile communication system.

Also, in many studies, it is predicted that traffic amount of mobile users will increase rapidly. An adoption of a new advanced physical layer technology or allocation of additional spectrums is being considered as the representative solutions to satisfy the above rapid explosive increase of traffic amount. However, technologies such as frequency modulation/demodulation, channel coding, and multi-antenna are already approaching their theoretical limits, and allocation of additional frequency spectrum also cannot be a fundamental solution for increasing capacities of cellular networks.

Therefore, for a method for supporting explosively increasing user data traffic in cellular networks, a method in which a plurality of small cells are deployed densely by reducing a size of each cell or a multi-layered cellular network is used for providing services may be considered as a realistic solution.

In the Long Term Evolution Advanced (LTE-Advanced) standardization of 3^{rd} Generation Partnership Project (3GPP), a standardization of small cell enhancements is being proceeded for accommodating demands of rapidly increasing mobile data efficiently.

However, only scenarios and requirements for small cell enhancements have been discussed until now, and detail procedures and methods for small cell enhancements have not been proposed yet.

### SUMMARY

Accordingly, example embodiments of the present invention are provided to substantially obviate one or more problems due to limitations and disadvantages of the related art.

An objective of the present invention is providing a method for configuring dual connectivity which makes a terminal be able to establish multiple connections with a plurality of cells in an environment in which a macro cell and a small cell co-exist.

In order to achieve the above-described objective of the present invention, a method for configuring dual connectivity according to an aspect of the present invention may provide a method for configuring dual connectivity, performed in a base station, the method comprising receiving, from a terminal, measurement information about a neighbor cell of the terminal; obtaining information for configuring dual connectivity from the terminal or the base station; determining whether to configure dual connectivity or not based on the measurement information and the information for configuring dual connectivity; and, if the dual connectivity is to be configured, transmitting a message instructing to configure the dual connectivity to the terminal.

Here, the information for configuring dual connectivity may include at least one of buffer status information of the terminal or the macro base station, service quality information of at least one bearer, movement speed information of the terminal, information about signal strength of the macro cell or the small cell.

Here, in the determining whether to configure dual connectivity, the terminal may connect to both a macro cell and a small cell when a movement speed of the terminal belongs to a predetermined reference speed range, and the terminal may connect to only the macro cell when the movement speed of the terminal is higher than the predetermined reference speed range, and the terminal may connect to only the small cell when the movement speed of the terminal is lower than the predetermined reference speed range.

Here, the transmitting a message instructing to configure the dual connectivity may further include, when the dual connectivity is determined to be configured, checking whether the neighbor cell which is a target of the measurement information supports dual connectivity; and, when the neighbor cell supports dual connectivity, transmitting a message instructing the terminal to configure the dual connectivity with the neighbor cell.

Here, the method may further include receiving, by the base station, terminal capability information from at least one terminal including the terminal; and managing the at least one terminal based on the received terminal capability information, wherein the terminal capability information includes information about at least one of whether to support dual connectivity, whether to be able to transmit uplink control channels in parallel, and whether to be able to receive downlink control channels in parallel.

Here, the method may further include managing, by the base station, connection information of at least one small cell, wherein the connection information includes information about at least one of identifier of the at least one small cell, position of the at least one small cell, and transmission power of the at least one small cell.

Here, the method may further include, prior to the receiving measurement information, transmitting information for searching small cells to the terminal, wherein the information for searching small cells includes information about at least one of frequency of at least one target small cell, bandwidth of at least one target small cell, transmission power of at least one target small cell, cell search period, and cell search time.

Also, the method may further include, prior to the receiving measurement information, transmitting a message instructing to search small cells to the terminal when a preconfigured small cell search condition is satisfied.

In order to achieve the above-described objective of the present invention, a method for configuring dual connectivity according to another aspect of the present invention may provide a method for configuring dual connectivity, performed in a base station, the method comprising determining whether to configure dual connectivity based on measurement information about a neighbor cell reported from a terminal; if it is necessary to configure the dual connectivity, transmitting a message requesting preparation of dual connectivity to a small cell base station with which the terminal will establish a connection; receiving an acknowledgement message for the message requesting preparation of dual connectivity from the small cell base station; and transmitting a message instructing a start of the dual connectivity to the terminal.

Here, the message requesting preparation of dual connectivity may include information about at least one of a terminal context of the terminal, a Cell Radio Network Temporary Identifier (C-RNTI) of the terminal, and at least one bearer to be used for dual connectivity.

Here, the acknowledgement message may include information about at least one of a physical layer of the small cell base station, resources of the small cell base station, a Cell Radio Network Temporary Identifier (C-RNTI) of the terminal, and a random access channel.

Here, the message instructing a start of the dual connectivity may be transmitted by using a RRC message, and the message instructing a start of the dual connectivity may include at least one of mobility control information, a dual connectivity indicator, information about a physical layer of the small cell base station, system information, information about at least one bearer, information about a random access channel, a Cell Radio Network Temporary Identifier (C-RNTI) information of the terminal

Here, the method may further include managing at least one bearer for the dual connectivity by the base station.

Also, in the managing at least one bearer for the dual connectivity, whether a related bearer is transmitted or not may be determined according to a channel state of the macro cell or the small cell, or information about the related bearer may be transmitted to the small cell base station, or data may be forwarded to the small cell base station.

In order to achieve the above-described objective of the present invention, a method for configuring dual connectivity according to the other aspect of the present invention may provide a method for configuring dual connectivity, performed in a base station, the method comprising determining whether to configure dual connectivity based on measurement information about a neighbor cell reported from a terminal; if it is necessary to configure the dual connectivity, transmitting a message instructing addition of a secondary cell (SCell) to a small cell base station; receiving an acknowledgement message for the message requesting instructing addition of a secondary cell (SCell) from the small cell base station; and transmitting a message instructing a start of the dual connectivity to the terminal.

Here, the message instructing addition of a secondary cell (SCell) may include at least to one of a terminal context information of the terminal, a Cell Radio Network Temporary Identifier (C-RNTI) of the terminal, and information about at least one bearer to be used for dual connectivity.

Here, the acknowledgement message may include information about at least one of a physical layer of the small cell base station, resources of the small cell base station, a Cell Radio Network Temporary Identifier (C-RNTI) of the terminal, and a random access channel.

Here, the message instructing a start of the dual connectivity may be transmitted by using a RRC message, and the message instructing a start of the dual connectivity may include at least one of information about parameters related to the addition of a SCell, an indication of non-ideal backhaul, a physical layer of the small cell base station, system information, information about at least one bearer, random access channel information, and a Cell Radio Network Temporary Identifier (C-RNTI) of the terminal.

Here, the method may further include transmitting a downlink control channel including information indicating a carrier to the terminal.

### BRIEF DESCRIPTION OF DRAWINGS

Example embodiments of the present invention will become more apparent by describing in detail example embodiments of the present invention with reference to the accompanying drawings, in which:

FIG. 1 is a view to compare a method for configuring dual connectivity and a method for configuring single connectivity;

FIG. 2 is a view to illustrate an environment for dual connectivity;

FIG. 3 is a view to illustrate a structure for dual connectivity which can be applied to an environment where a macro cell is overlapped with a small cell;

FIG. 4 is a conceptual diagram to illustrate a procedure for a terminal to configure dual connectivity;

FIG. 5 is a flow chart to illustrate a method for managing inter-site CA performed in a macro base station;

FIG. 6 is a view to illustrate a determination of inter-site CA based on collected information and changes on related specifications;

FIG. 7 is a view to compare a method using hand-over procedures with a method using CA procedures among methods for configuring dual connectivity;

FIG. 8 is a flow chart illustrating a method for configuring dual connectivity by using a method to which the handover procedure is extended;

FIG. 9 is a flow chart illustrating a method for configuring dual connectivity by using a method to which the CA procedure is extended;

FIG. 10 is a view illustrating comparison between methods for configuring dual connectivity by using a method to which conventional handover procedure is extended and a method to which conventional CA procedure is extended;

FIG. 11 is a flow chart illustrating a method for configuring dual connectivity by using a method extending RRC connection procedure; and

FIG. 12 is a flow chart illustrating a random access procedure performed in the procedure for configuring dual connectivity.

### DETAILED DESCRIPTION

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “terminal” used in this specification may be referred to as User Equipment (UE), a User Terminal (UT), a wireless terminal, an Access Terminal (AT), a Subscriber Unit (SU), a Subscriber Station (SS), a wireless device, a wireless communication device, a to Wireless Transmit/Receive Unit (WTRU), a mobile node, a mobile, or other words. The terminal may be a cellular phone, a smart phone having a wireless communication function, a Personal Digital Assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, or also a portable unit or terminal having a combination of such functions. However, the terminal is not limited to the above-mentioned units.

Also, the term “base station” used in this specification means a fixed point that communicates with terminals, and may be referred to as another word, such as Node-B, eNode-B, a base transceiver system (BTS), an access point, etc. Also, the term “base station” means a controlling apparatus which controls at least one cell. In a real wireless communication system, a base station may connect physically to and control a plurality of cells. In this case, the base station may be regarded to comprise a plurality of logical base stations. That is, parameters configured for each cell are assigned by the corresponding base station.

Also, the term “network” used in this specification may include a mobile internet such as a Wireless Fidelity (WIFI), a Wireless Broadband Internet (WiBro), and a World Interoperability for Microwave Access (WiMax). Also, it may include 2G cellular networks such as a Global System for Mobile communication (GSM) and a Code Division Multiple Access (CDMA), 3G cellular network such as a Wideband Code Division Multiple Access (WCDMA) and a CDMA2000. Also, it may include 3.5G cellular network such as a High Speed Downlink Packet Access (HSDPA) and a High Speed Uplink Packet Access (HSUPA). Also, it may include 4G or beyond 4G cellular network such as a Long Term Evolution (LTE) and a LTE-Advanced.

Hereinafter, embodiments of the present invention will be described in detail with reference to the appended drawings. In the following description, for easy understanding, like numbers refer to like elements throughout the description of figures, and the same elements will not be described further.

The main objective of technologies for small cell enhancements, which have been discussed in 3GPP standardization conferences from 2013, includes a study on a technique of dual connectivity having an inter-eNB connection structure for enhancing transmission performance and mobility in a non-ideal backhaul structure which cannot support compatibility with the 3GPP release-11 standards.

The non-ideal backhaul means a backhaul in which base stations (or, transmission points) are connected through a wireless network having lower performances than a wired network using optic cables. Also, a small cell may mean a pico cell managed by a communication operator. However, a small cell may mean a home base station such as a Home eNB, HeNB, or a femto cell.

The dual connectivity has been discussed based on a scenario in which a macro cell is overlapped with a small cell, and includes both an inter-frequency structure and an intra-frequency structure. The dual connectivity is being discussed based on the following deployment scenarios.
Scenario 1: A structure in which a macro cell and a small cell, which use the same carrier frequency (that is, intra-frequency case), are connected through non-ideal backhaul.
Scenario 2: A structure in which a macro cell and a small cell, which use different to carrier frequencies (that is, inter-frequency case), are connected through non-ideal backhaul.
Scenario 3: A structure in which only small cells using one or more carrier frequencies are connected through non-ideal backhaul.

The dual connectivity may mean a technology enabling a terminal to configure and maintain multiple radio connections with multiple base stations. In an aspect of Carrier Aggregation (hereinafter, referred to as ‘CA’), it may mean that a physical layer can use multiple carriers and each of the carriers is managed by different base station.

Meanwhile, a single connectivity may mean a technology enabling a terminal to configure and maintain a single radio connection with a single base station. Also, in an aspect of CA, it may mean that a physical layer can use multiple carriers, but all carriers are managed by the single base station.

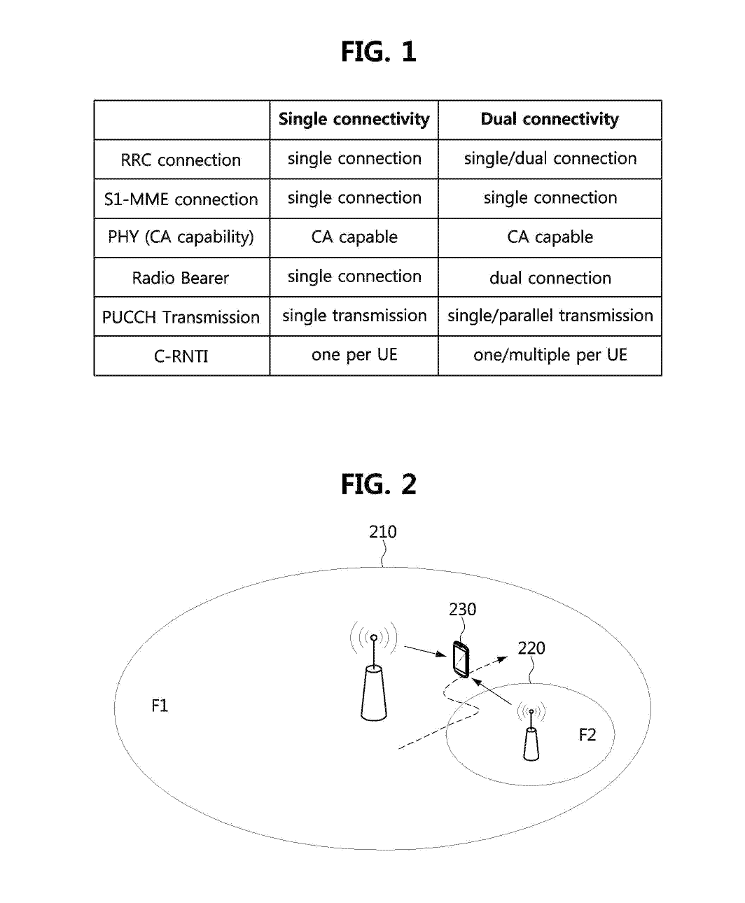

FIG. 1 is a view to compare a method for configuring dual connectivity and a method for configuring single connectivity.

Referring to FIG. 1, in aspect of a Radio Resource Control (RRC) connection, for the dual connectivity case, a terminal may have one or more connections with base stations. For the single connectivity case, a terminal may have a single connection with a base station. In aspect of a S1-Mobility Management Entity (S1-MME) connection, a terminal may have a single connection for both the dual connectivity case and the single connectivity case. In aspect of a physical layer (CA capability), both the dual connectivity case and the single connectivity case may support carrier aggregation (CA). In aspect of radio bearer, the dual connectivity case supports multiple connections, and the single connectivity case supports only a single connection. In aspect of transmission of Physical Uplink Control Channel (PUCCH), the dual connectivity case supports a single or parallel transmission, and the single connectivity case supports only a single transmission. In aspect of a Cell Radio Network Temporary Identifier (C-RNTI), the dual connectivity case supports one or more C-RNTIs for a single terminal, and the single connectivity case supports a single C-RNTI for a terminal.

The objective of the dual connectivity is to enhance mobility and performances of transmission and power conservation by performing communications using all advantages of macro cells and small cells. A small cell may be configured as a stand-alone base station, and a plurality of communication paths may be provided to a terminal by connecting a macro cell and small cells in an inter-eNB structure manner.

FIG. 2 is a view to illustrate an environment for dual connectivity.

In FIG. 2, an example of an environment supporting dual connectivity when a small cell 220 is located within a macro cell 210 is illustrated.

In FIG. 2, the macro cell 210 may be configured to use a frequency band F1 and the small cell 220 may be configured to use a frequency band F2. Also, an ideal backhaul or a non-ideal backhaul may be formed between the macro cell 210 and the small cell 220. In the present invention, it is assumed that the macro cell 210 and the small cell 220 are connected through a non-ideal backhaul.

A terminal 230 may establish connections with the macro cell 210 and the small cell 220 respectively, and be provided with services from the macro cell 210 and/or the small cell 220.

Meanwhile, for the dual connectivity, a change on standard specifications is necessary for specifying how a terminal and base stations establish multiple connections. Therefore, demanded is a method which can enhance terminal performance while minimizing impacts on standard specifications and complexity of implementation.

Hereinafter, a structure for dual connectivity will be explained.

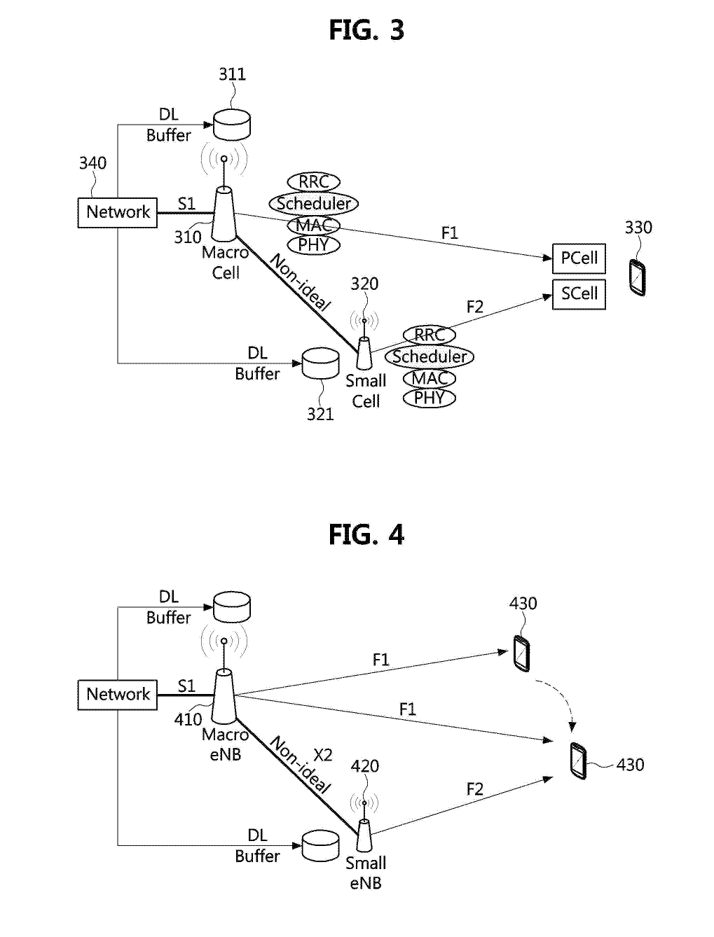

FIG. 3 is a view to illustrate a structure for dual connectivity which can be applied to an environment where a macro cell is overlapped with a small cell.

Referring to FIG. 3, in an environment in which a macro cell is overlapped with a small cell, the macro cell may be configured to use a frequency band F1, and the small cell may be configured to use a frequency band F2. Also, the macro base station 310 and the small cell base station 320 may be connected through non-ideal backhaul.

The macro base station 310 can be expanded so as to include a function of a gateway (GW) of macro cell as well as a function of the small cell base station 320, and may be connected to a Mobility Management Entity (MME)/a Serving Gateway (SGW) located in a core network (CN) 340 through a 51 interface.

A terminal 330 which is connected to the macro base station 310 may be managed as described in the conventional standard specification, and the MME/SGW may also be configured to operate without changes of the standard specification. The macro base station 310 may transfer traffic delivered from the SGW through a GPRS tunneling protocol (GTP) tunnel to the macro cell and the small cell.

A terminal 330 which is also connected to the small cell base station 320 may be managed in a manner identical to a manner in which a home base station (HeNB) uses a home base station gateway (HeNB GW). The terminal 330 connected to the small cell may be controlled through a RRC located in the small cell base station 320, and may use an access procedure identical to that of the conventional 3GPP release-11 standards.

On the other hand, when a terminal operating in single connectivity state performs a function of dual connectivity, the macro cell becomes a main cell (or, a serving cell, an anchor cell, etc.), and a Packet Data Convergence Protocol (PDCP) buffer is located in the macro cell. Or, in aspect of CA, the macro cell may be a primary cell (PCell), and the small cell may be a secondary cell (SCell). For this, if a terminal becomes connected to a small cell and then performs a function of dual connectivity, it should perform a procedure for changing a macro cell to a main cell (for example, through a handover procedure). Each of the macro base station and the small cell base station has a scheduling function to manage radio resources, transmits Physical Downlink Control Channel (PDCCH) to the terminal, and receives Physical Uplink Control Channel (PUCCH) from the terminal. In aspect of scheduling, downlink buffers 311 and 312 may be located in the macro base station 310 and the small cell base station 320 respectively. However, in aspect of implementation, an endpoint of the buffers may become the macro base station 310.

Hereinafter, a physical layer structure for dual connectivity will be described.

In order for dual connectivity to be applied, a terminal should maintain connections with a macro cell and a small cell respectively, and changes on standard specifications for a physical layer are needed.

According to capability of terminal, an operation structure for dual connectivity may become different. According to uplink transmission capability, a terminal may be classified into a terminal which can transmit PUCCHs in parallel and a terminal which can only transmit a single PUCCH.

The terminal which can transmit PUCCHs in parallel may mean a terminal whose functionality is expanded so that it can transmit PUCCHs to two cells in parallel differently from the conventional 3GPP release-11 specifications. That is, according to the conventional release 11 specification, a terminal supporting CA can transmit PUCCH only in to PCell and cannot transmit PUCCH in SCell. However, the functionality of the CA capable terminal (UE) may be expanded so that the CA capable terminal can transmit PUCCHs in parallel. The terminal can configure and transmit PUCCH for each base station, and configuration of PUCCH can be performed for each base station via RRC message. The terminal may transmit Physical Hybrid ARQ Indicator Channel (PHICH), Channel Quality Indicator (CQI) report, Scheduling Request for each cell via parallel PUCCH transmission. Meanwhile, it may be difficult for a terminal to simultaneously transmit PUCCHs in parallel due to a problem of power restriction, etc. In this case, configuration values for PUCCHs may be controlled differently so that a terminal can transmit PUCCHs in temporally distributive manner.

The terminal which can transmit a single PUCCH may mean a terminal whose functionality is expanded so that they can transmit PUCCH to two cells differently from the conventional 3GPP release-11 specifications. For example, a terminal may configure a single transmitter to transmit PUCCHs to two different cells by switching the transmitter temporally. Or, in case of a non-CA capable terminal, the non-CA capable terminal may be configured to transmit PUCCHs to a plurality of cells at different times. Or, even in intra-frequency structure, a terminal may be configured to transmit PUCCHs to a plurality of cells in time division or frequency division multiplexing manner.

In the environment to which dual connectivity is applied, a terminal may transmit a scheduling request (SR) to each base station. Each base station which receives the scheduling request from the terminal may notify an uplink grant to the terminal by transmitting PDCCH using at least one downlink carrier used in its cell.

A terminal may transmit a buffer status report (BSR) via Physical Uplink Shared Channel (PUSCH), and transmit the PUSCH by using a corresponding uplink carrier. Here, to when the terminal transmits BSR, it can transmit the BSR by indicating only BSR information related to a single base station. For example, when radio bearers managed by a small cell are a bearer No. 2 and a bearer No. 3, the terminal can transmit the BSR in which buffer information are indicated as for the bearer No. 2 and the bearer No. 3. The base station which receives the BSR from the terminal may transmit an uplink grant so as to make the terminal transmit data.

In a structure in which a single bearer is managed by two base stations, a terminal can transmit BSR to two base stations. In this case, a base station transmits uplink grant to the terminal by using BSR information received from the terminal. The terminal can minimize errors of buffer information by transmitting BSR for the corresponding bearer with short intervals. At this time, the BSR information may be transmitted in a piggyback form, or transmitted using padding regions. Also, the terminal may reduce the size of BSR by transmitting the BSR for representing information about only one bearer.

On the other hand, according to downlink receiving capability, a terminal may be classified into a terminal which can receive Physical Downlink Control Channels (PDCCHs) in parallel and a terminal which can receive a single PDCCH.

The terminal which can receive PDCCHs in parallel may mean a CA capable terminal which can receive PDCCHs via carriers having different frequencies.

The terminal which can receive a single PDCCH may mean a non-CA capable terminal having a single receiver to receive PDCCH through a plurality of frequencies. For example, the terminal can receive PDCCH by switching frequencies temporally, and the terminal can also receive PDCCH in an intra-frequency structure by time division or frequency division multiplexing. Or, the terminal can receive PDCCH transmitted through a different frequency in a configured gap time by using a manner similar to a manner using measurement gap, or can receive PDCCH transmitted through a different frequency in a configured time by using a manner similar to a manner using Multicast Broadcast Single Frequency Network (MBSFN) subframes. Or, the terminal can receive PDCCH transmitted through a different frequency by using a manner similar to Discontinuous Reception (DRX). Or, the terminal can receive PDCCH by performing the reception through a different frequency in a configured time by using a manner similar to an uplink bundling.

Hereinafter, a procedure for a terminal to configure dual connectivity, in a structure in which a macro base station and a small cell base station are connected through non-ideal backhaul, will be described. Hereinafter, a terminal is assumed to be a terminal capable of supporting CA and transmitting PUCCHs in parallel.

FIG. 4 is a conceptual diagram to illustrate a procedure for a terminal to configure dual connectivity.

Referring to FIG. 4, a macro base station 410 and a small cell base station 420 are connected through non-ideal backhaul. The macro cell uses a frequency band F1 and the small cell uses a frequency band F2.

In a state (RRC_CONNECTED) in which a terminal 430 established a RRC connection with the macro base station 410, when the terminal 430 approaches a coverage of the small cell base station 420, the terminal 430 is required to establish an additional connection with the small cell base station 420. Or, even when the terminal 430 is located in the coverage of the small cell base station 420, the terminal 430 may maintain a single connection with the macro base station 410, and may operates in RRC_CONNECTED state. In this case, if the terminal desires to transmit a large amount of data, the terminal can attempt to connect to the small cell base station 420.

A function of a macro base station for managing dual connectivity may be defined as inter-site carrier aggregation. That is, the inter-site CA may mean a CA technique using two or more cells located in different transmission and reception positions. A macro base station has a functionality of inter-site CA.

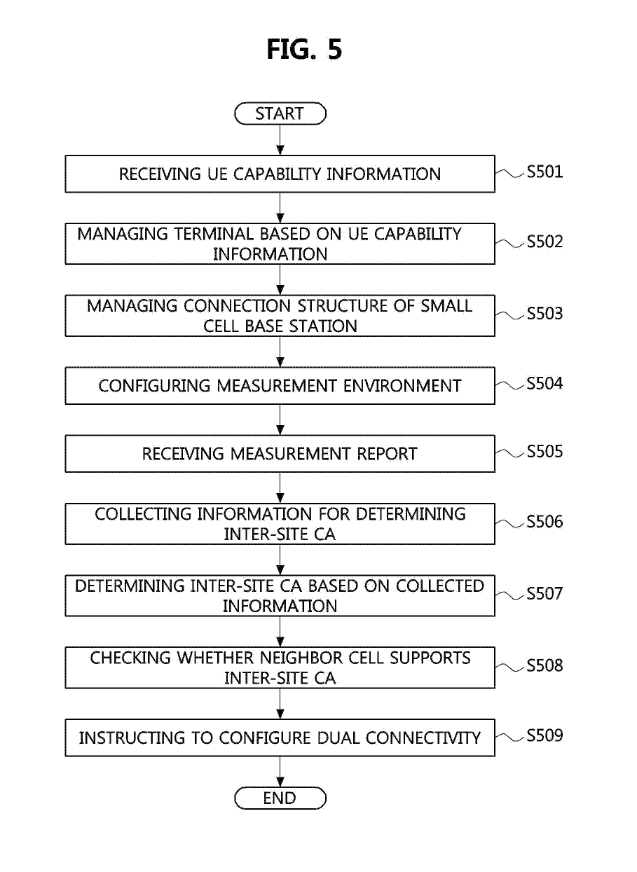

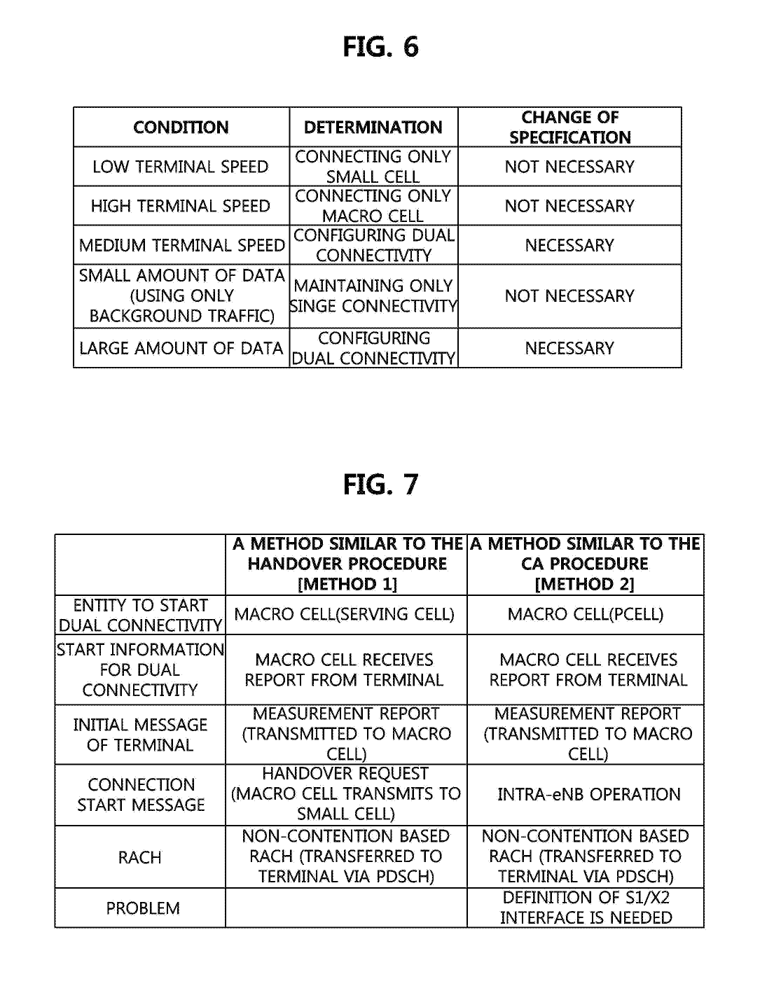

FIG. 5 is a flow chart to illustrate a method for managing inter-site CA performed in a macro base station. Also, FIG. 6 is a view to illustrate a determination of inter-site CA based on collected information and changes on related specifications.

Referring to FIG. 5, first, a macro base station receives UE capability information from a terminal (S501).

The macro base station manages the corresponding terminal based on the UE capability information reported from the terminal (S502). Here, the UE capability information reported from the terminal may include information about whether to support inter-site CA or not (that is, whether to support inter-frequency and/or intra-frequency), whether to support single PUCCH (PDCCH) transmission (reception), and whether to support PUCCHs (PDCCHs) transmission (reception) in parallel. For reporting the UE capability information, a new field can be added to a reporting procedure of a terminal according to the 3GPP release-11 specification. For example, if a terminal supports dual connectivity, the terminal can report its capability by indicating that it is a dual connectivity capable terminal.

Also, the macro base station may manage connection structure of small cells (S503). For this, a new network message may be introduced or a function of Operation, Administration and Maintenance (OAM) may be used. For example, the macro base station can manage a list of small cells which can support dual connectivity. The list of small cells may include information about identity numbers of small cell base stations, positions of small cell base stations, transmission powers of small cell base stations, etc. Meanwhile, each of the small cell base stations can manage information about the macro cell. The step S503 may be performed at any time, regardless of execution order of other steps.

The base station may configure measurement environment in order for a terminal to measure signals from at least one neighbor cell (S504). That is, the base station configures measurements for the terminal to perform measurement on at least one neighbor cell, and notify the measurement configuration information to the terminal. Here, the measurement environment can be configured identically to that of measurement procedures for handover, and at least one measurement gap for inter-frequency measurement can be employed.

After the terminal performs measurements on the at least one corresponding neighbor cell based on the measurement configuration information provided from the base station, the terminal reports measurement report to the macro base station (S505). Here, the terminal may report Reference Signal Received Power (RSRP) and/or Reference Signal Received Quality (RSRQ) information as the measurement report. Also, since the measurement performed by the terminal is a measurement for dual connectivity, measurement conditions different from conditions for handover may be applied. For example, a threshold power level lower than that for handover may be configured so that dual connectivity can be maintained.

Also, a macro base station or a terminal collects information for determination of inter-site CA. Here, the macro base station can collect information from a terminal, a small cell base station and/or other macro base station. The examples of the collected information may be as follows.
Buffer status: dual connectivity is configured when the amount of data is large.
Service quality (QoS) of bearer: dual connectivity is configured when there is a high possibility that continuous services can be maintained.
Movement speed of terminal: dual connectivity is configured when the speed of the terminal is in medium-level (in a predefined range of speed).
Information about signal strength of macro cell and/or small cell: dual connectivity is configured when signal of a macro cell is stable, and signal of a small cell is equal to or higher than a threshold value, and information about the small cell is obtained.

Referring to FIG. 6, the macro base station can make the terminal connect to only small cell based on the collected movement speed information of the terminal when the movement speed of the terminal is low. Change of the standard specification according to this case is not necessary. When the movement speed of the terminal is high, the terminal can be made to connect to only macro cell. Also, change of the standard specification according to this case is not necessary. When the movement speed of the terminal is in medium-level, dual connectivity making the terminal connect to both macro cell and small cell may be configured. Change of the standard specification according to this case becomes necessary. Here, the movement speed of the terminal can be determined according to preconfigured criteria. For example, the criteria for the movement speed of terminal may be configured as a specific speed range in advance. If the movement speed of terminal is below the specific speed range, the movement speed of terminal can be determined as a low speed. Also, if the movement speed of terminal is over the specific speed range, the movement speed of terminal can be determined as a high speed.

Meanwhile, when the amount of data to be transmitted to or received from a terminal is small (for example, when a terminal is using only background traffic), the macro base station may configure the terminal to maintain only a single connection. On the contrary, when the amount of data is large, dual connectivity can be configured, and change of the specification for this becomes necessary.

The macro base station determines whether to configure inter-site CA based on the above-described collected information (S507). In FIG. 5, an example in which the macro base station determines whether to configure inter-site CA based on the collected information is illustrated.

If the inter-site CA is determined to be necessary, the macro base station checks whether a neighbor cell included in the measurement report information transmitted from the terminal supports inter-site CA (S508).

If the corresponding neighbor cell supports inter-site CA, the macro base station instructs the terminal to start procedures for dual connectivity with the neighbor cell (S509).

In response to the instruction to start the dual connectivity procedures, the terminal performs the dual connectivity procedures with the corresponding neighbor cell.

The dual connectivity procedure which can be used by the terminal may be one of the following methods.

[Method 1] A method to which the conventional handover procedure is extended: The macro cell may manage status of the terminal and instruct the terminal to configure dual connectivity.

[Method 2] A method to which the conventional CA procedure is extended: The macro cell may instruct the terminal to configure addition of SCell/Secondary Timing Advance Group (STAG).

[Method 3] A method to which the RRC procedure is extended (that is, a UE controlled method): The terminal may connect to a small cell, and then the network may manage dual connectivity.

FIG. 7 is a view to compare a method using hand-over procedures with a method using CA procedures among methods for configuring dual connectivity.

As shown in FIG. 7, an entity to initiate dual connectivity may be a macro cell for both the method 1 and the method 2, and information for initiating dual connectivity may be reported from a terminal to the macro cell in the cases of both the method 1 and the method 2. An initial message of the terminal for dual connectivity is the measurement report message transmitted from the terminal to the macro cell in the cases of both the method 1 and the method 2. A dual connectivity initiation message may be a handover request message transmitted from the macro cell to a small cell in the method 1, and an intra-eNB operation message in the method 2. Also, the terminal performs a random access procedure (or, a RACH procedure) using non-contention based Random Access Channel (RACH) for both the method 1 and the method 2. Information for this may be transferred to the terminal via PDSCH in the case of the method 1 and via PDCCH in the case of the method 2. Meanwhile, definition of S1/X2 interface for configuring dual connectivity by using the method 2 is demanded.

When the dual connectivity is configured, the terminal may transmit and receive data through two paths. As a method for allocating path for data transmission and reception, one of a method in which a single S1 bearer is mapped to two terminal bearers (UE bearers) and a method in which only one-to-one mapping is allowed may be applied. The former method in which a single S1 bearer is mapped to two terminal bearers is a method in which a single terminal specific bearer (a UE dedicated bearer) is distributed to the small cell and the macro cell. In this case, a distributor may be needed. The latter method of one-to-one mapping is a method in which a bearer is mapped statically, that is, a specific terminal bearer is mapped to a specific cell statically. For example, a first terminal specific bearer may be mapped to the small cell, and a second terminal specific bearer may be mapped to the macro cell. At this time, a signaling radio bearer (SRB) may be connected to both cells.

Hereinafter, each step of the above-described dual connectivity procedures will be explained in detail.

First, a method for configuring dual connectivity by using the method to which the handover procedure is extended (the method 1) is explained.

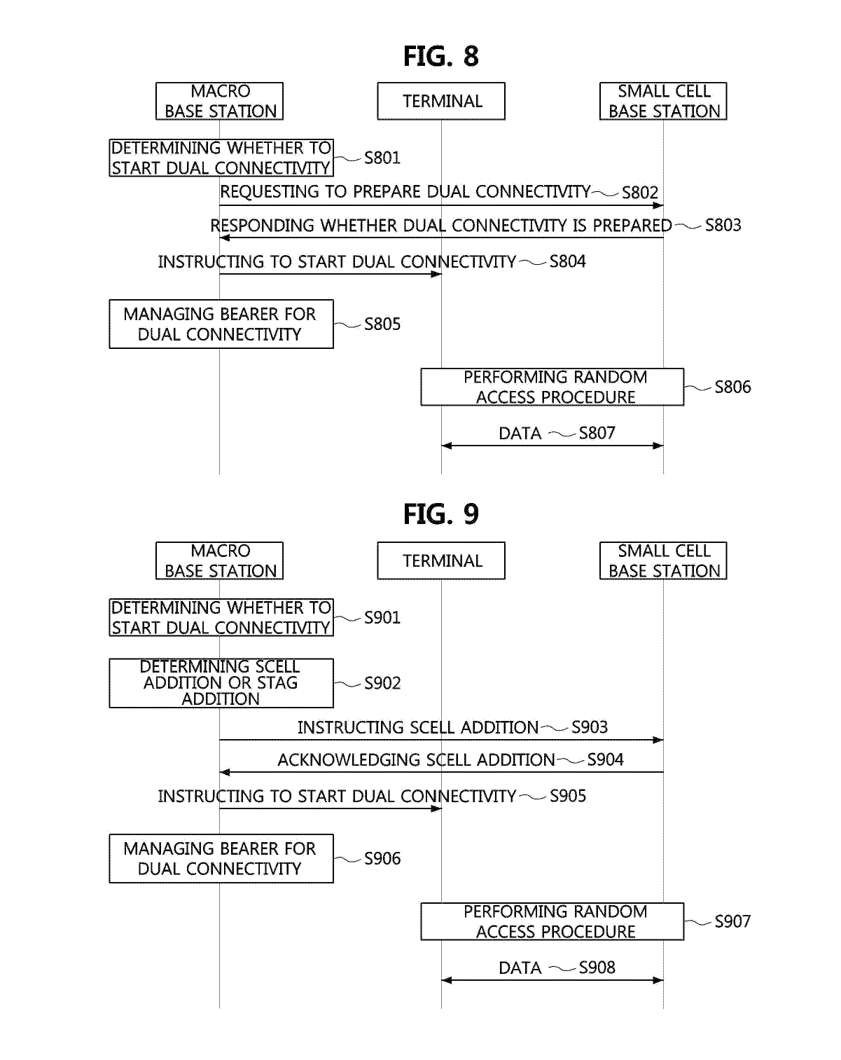

FIG. 8 is a flow chart illustrating a method for configuring dual connectivity by using a method to which the handover procedure is extended, and illustrates an example in which a method to which the handover procedure defined in 3GPP release-11 specifications is extended is applied to configuration of dual connectivity.

As described above, when the macro base station receives the measurement report information from the terminal, the macro base station determines whether to initiate configuration of dual connectivity based on the received measurement report information and/or collected information (S801).

If the macro base station determines that configuration of dual connectivity is necessary, the macro base station transmits a message requesting to prepare dual connectivity to a small cell base station (S802). Here, the macro base station may transmit the message requesting to prepare dual connectivity to the small cell base station via X2 interface, and the message requesting to prepare dual connectivity may be a handover request message or a dual connectivity request message. The message requesting to prepare dual connectivity may include information about terminal context (UE context), C-RNTI, at least one bearer to be used for dual connectivity (for example, a bearer ID), etc.

If the small cell base station receives the message requesting to prepare dual connectivity from the macro base station, the small cell base station checks the received message, determines whether to allow configuration of dual connectivity, and then transmits an acknowledgement message for the message requesting to prepare dual connectivity (S803). Here, the small cell base station may transmit the acknowledgement message to the macro base station via X2 interface, and the acknowledgement message may be a handover request ACK message or a dual connectivity ACK message. Also, the acknowledgement message may include information about physical channels of the small cell, resources of the small cell, RACH (non-contention based RACH), etc.

Then, the macro base station transmits a message instructing start of configuring dual connectivity to the terminal (S804). Here, the macro base station may transmit the message instructing start of configuring dual connectivity via a RRC message (for example, RRCConnectionReconfig). Also, the message instructing start of configuring dual connectivity may include information about mobility control (mobiltityControllnfo), a dual connectivity indicator, physical layers of the small cell, system information, bearer information, RACH (non-contention based RACH) information, C-RNTI, etc.

The macro base station manages bearers for dual connectivity as follows (S805).
For dual connectivity, the macro base station may transmit data being transmitted continuously when channel state of the macro cell is good, and may stop transmitting the corresponding bearer when channel state of the macro cell becomes bad.
The macro base station may transmit information about bearers stopped or being transmitted to the small cell base station (by using X2 interface).
When data forwarding is necessary, the macro base station may perform data forwarding to the small cell base station.

If the terminal receives the message instructing start of configuring dual connectivity from the macro base station, the terminal may perform a random access procedure for connecting to the small cell (S806). Here, the terminal may transmit non-contention based RACH to the small cell base station, and the small cell base station may make the terminal configure uplink synchronization by transmitting a Random Access Response (RAR) message (or, Message 2) in response to the RACH. Then, the terminal reports completion of radio procedures to the small cell base station by using a RRC message (for example, RRCConnectionReconfig Complete or Dual Connectivity Complete).

Then, the small cell base station starts transmitting data to the terminal (S807). At this time, the macro base station may maintain a signaling radio bearer (SRB) with the terminal. Also, the macro base station may maintain a data radio bearer (DRB) with the terminal.

A procedure that the small cell base station requests a MME to switch a bearer to the small cell (for example, a Path Switch Request) may be omitted.

A procedure that the MME modifies information of SGW so as to make traffic be transferred to the small cell may be omitted.

A procedure that the small cell instructs to release a terminal context (UE context) of the macro cell may be omitted.

Hereinafter, the method to which the CA procedure is extended is explained.

FIG. 9 is a flow chart illustrating a method for configuring dual connectivity by using a method to which the CA procedure is extended, and illustrates an example in which a method to which SCell addition procedure defined in 3GPP release-11 specifications is extended is applied to configuration of dual connectivity.

Referring to FIG. 9, when the macro base station receives the measurement report information from the terminal, the macro base station determines whether to initiate configuration of dual connectivity based on the received measurement report information and/or collected information (S901).

If the macro base station determines that configuration of dual connectivity is necessary, the macro base station determines SCell addition or STAG addition (S902).

Then, the macro base station transmits a message instructing SCell addition to the small cell base station (S903). Here, the macro base station may transmit the message for SCell addition to the small cell base station via X2 interface, and the SCell addition message may be, for example, a handover request message or a dual connectivity request message. Also, the SCell addition message may include information about terminal context (UE context), C-RNTI, at least one bearer to be used for dual connectivity (for example, IDs of the at least one bearer), etc.

If the small cell base station receives the SCell addition message from the macro base station, the small cell base station transmits an acknowledgement message indicating completion of SCell addition to the macro base station in response to the SCell addition message (S902). Here, the small cell base station may transmit the acknowledgement message to the macro base station via X2 interface, and the acknowledgement message may be a handover request ACK message or a dual connectivity ACK message. Also, the acknowledgement message may include information about physical channels of the small cell, resources of the small cell, RACH (non-contention based RACH), etc.

Then, the macro base station transmits a message instructing a start of configuring dual connectivity to the terminal (S905). Here, the macro base station may transmit the message instructing start of configuring dual connectivity via a RRC message (for example, RRCConnectionReconfig). Also, the message instructing start of configuring dual connectivity may include STAG-ToAddMod, SCellToAddModList, dial connectivity indicator, information indicating non-ideal backhaul, physical layers of the small cell, system information, bearer information, RACH (non-contention based RACH) information, C-RNTI, etc. The STAG-ToAddMod may include a parameter (stag-ID) indicating timing advance group (TAG) of SCell and a parameter (timeAlignmentTimerSTAG) indicating a value of time alignment timer.

Meanwhile, the macro base station manages bearers for dual connectivity as follows (S906).
For dual connectivity, the macro base station may transmit data being transmitted continuously when channel state of the macro cell is good, and may stop transmitting the corresponding bearer when channel state of the macro cell is bad.
The macro base station may transmit information about bearers stopped or being transmitted to the small cell base station (by using X2 interface).
When data forwarding is necessary, the macro base station may perform data forwarding to the small cell base station.

If the terminal receives the message instructing start of configuring dual connectivity from the macro base station, the terminal may perform a random access procedure for connecting to the small cell (S907). Here, the terminal may transmit non-contention based RACH to the small cell base station, and the small cell base station may make the terminal configure uplink synchronization by transmitting a Random Access Response (RAR) message (or, Message 2) in response to the RACH. Then, the terminal reports completion of radio procedures to the small cell base station by using a RRC message (for example, RRCConnectionReconfig Complete or Dual Connectivity Complete).

Then, the small cell base station starts transmitting data to the terminal (S908). At this time, the macro base station may maintain a signaling radio bearer (SRB) with the terminal. Also, the macro base station may maintain a data radio bearer (DRB) with the terminal.

Since the macro base station can transfer data to be transmitted to the terminal to the small cell base station via X2 interface, additional X2 interfaces for configuring dual connectivity is not necessary.

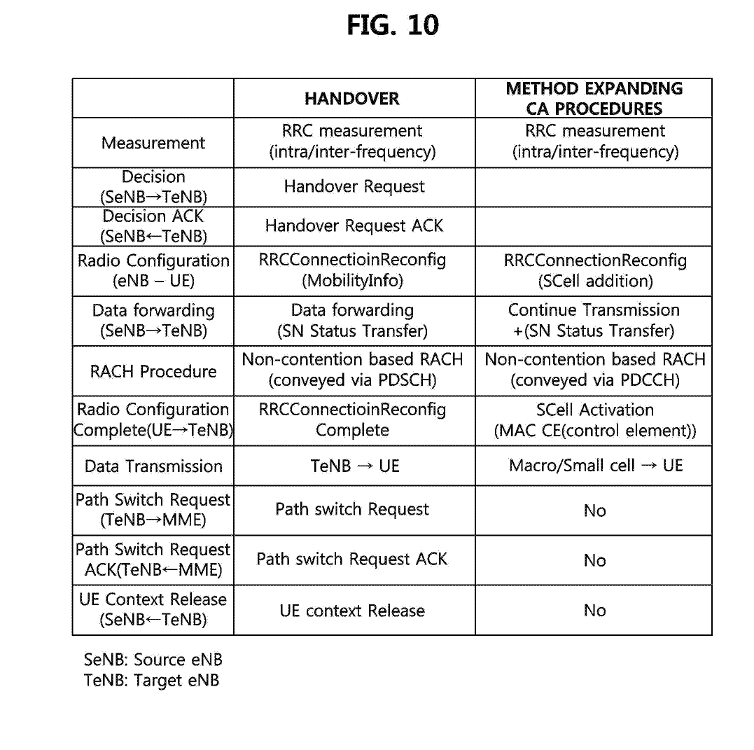

FIG. 10 is a view illustrating comparison between methods for configuring dual connectivity by using a method to which conventional handover procedure is extended and a method to which conventional CA procedure is extended.

As shown in FIG. 10, for the method for configuring dual connectivity by using a method extending CA procedure, a determination procedure and a determination acknowledgement procedure for configuring dual connectivity are required to be newly defined. In the present invention, an example for them was explained through the steps S903 and S904 by referring to FIG. 9.

Also, in the method extending CA procedure, the data forwarding and random access procedure are different from those of a general handover procedure. That is, in the method extending CA procedure, the macro base station can transmit data to be transmitted to the terminal to the small cell base station continuously. Accordingly, both the macro base station and the small cell base station can transmit data to the terminal. Also, although a terminal is provided with information needed for transmitting non-contention based RACH via PDSCH in the conventional handover procedure, in the method extending CA procedure, a terminal is provided with information needed for transmitting RACH to the small cell base station from the macro base station via PDCCH.

Also, in the method for configuring dual connectivity by using a method extending CA procedure, procedures for Path Switch Request, Path Switch Request ACK, and UE Context Release, which are performed in the conventional handover procedure, are not needed to be performed.

Hereinafter, the method for configuring dual connectivity by using a method extending RRC connection procedure will be explained. The method for configuring dual connectivity by using a method extending RRC connection procedure is similar to a method for a terminal in RRC_IDLE state to access a small cell base station.

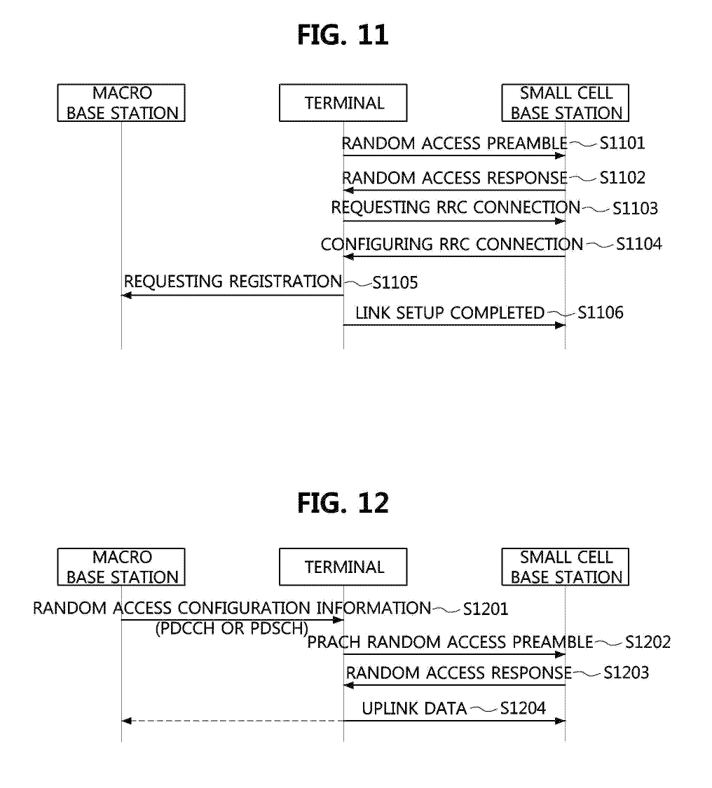

FIG. 11 is a flow chart illustrating a method for configuring dual connectivity by using a method extending RRC connection procedure.

Referring to FIG. 11, first, a terminal transmits a non-contention based random access preamble to a small cell base station (S1101).

The small cell base station transmits a Random Access Response (RAR) (or, Message 2) to the terminal in response to the random access preamble received from the terminal (S1102). Here, the RAR message may include information such as temporary C-RNTI, Timing Advance (TA) information, etc.

Then, the terminal transmits a RRC connection request message (RRCConnectionRequest) (or, a Message 3) to the small cell base station (S1103). Here, the RRC connection request message may include SAE-Temporary Mobile Subscriber Identity (S-TMSI).

The small cell base station configures a link of the terminal based on the RRC connection request message, and transmits a RRC connection setup message (RRCConnectionSetup) to the terminal (S1104).

The terminal transmits a message (Attach Request) requesting registration to the MME (S1105). Since a gateway (GW) functional element in the macro base station acts a role of the MME by performing a proxy function, the terminal may transmit the message requesting registration to the macro base station. The message requesting registration may include a terminal identifier (for example, an International Mobile Subscriber Identity (IMSI), or a Globally Unique Temporary Identifier (GUTI)).

The GW functional element performing MME functions in the macro base station compares information received from the terminal with terminal information managed by it, and recognizes the terminal when the two information are identical and they correspond to a configuration for dual connectivity.

Here, the GW functional element of the macro base station does not transmit the terminal information to a core network (Evolved Packet Core (that is, EPC)).

The terminal transmits a link setup complete message (RRCConnectionSetupComple) to the small cell base station (S1106). The link setup complete message may include information such as Public Land Mobile Network (PLMN) ID, MME Group Identifier (MMEGI), MME code (MMEC), etc.

Hereinafter, a random access procedure performed by a terminal in the procedure for configuring dual connectivity will be explained.

FIG. 12 is a flow chart illustrating a random access procedure performed in the procedure for configuring dual connectivity.

When a terminal moving from a macro cell to a small cell performs a random access procedure with the small cell base station to configure connection to the small cell, a non-contention based random access procedure is performed to avoid collision and perform the connection setup procedure rapidly. For this, the macro base station transfers configuration information for the random access to the terminal by using PDCCH or PDSCH (S1201). Here, the information transferred from the macro base station to the terminal may include Physical Random Access Channel (PRACH) radio resource position information, PRACH time information, uplink information, etc.

The terminal transmits PRACH to the small cell base station according to the information transferred from the macro base station (S1202).

If the small cell base station receives PRACH from the terminal, the small cell base station transmits a Random Access Response (RAR) message to the terminal through a downlink channel (for example, PDSCH) (S1203). At this time, the RAR message may include uplink synchronization information and information about resources of uplink channel (for example, PDSCH) to be used by the terminal. The information about resources of uplink channel may include carrier information so that the terminal can transmit uplink channel to the macro base station by using the carrier information. Also, the small cell base station transmits information about at least one resource to the terminal so as to instruct the terminal to perform uplink transmission to the macro cell and the small cell. In this case, the terminal transmits uplink signal to the macro base station after receiving the RAR message from the small cell base station so that the macro base station can obtain the terminal information regardless of backhaul latency. The resources for transmitting uplink signal to the macro cell may be allocated to the small cell base station by the macro base station in advance, and information about the resources may be transferred from the small cell base station transmits to the terminal.

Then, the terminal may acquire information for uplink synchronization and uplink resources from the small cell base station through the RAR message, and transmit uplink data (or, uplink channel) to the small cell base station by using the acquired information. At this time, terminal can also transmit data to the macro cell additionally. Also, the terminal can transmit uplink data to the macro cell and the small cell simultaneously, and also transmit the same data to the macro cell and the small cell.

When the small cell base station receives uplink data from the terminal, the small cell base station can identify that configuration of dual connectivity has been completed. Also, the macro base station can identify that configuration of dual connectivity has been completed successfully by receiving data from the terminal. Since the macro base station and the small cell base station are connected through non-ideal backhaul, if it is identified that configuration of dual connectivity has been completed successfully through the above-described procedure, function of dual connectivity may be used rapidly. That is, the macro base station may stop or minimize services being provided to the terminal so that the terminal can mainly communicate with the small cell.

Hereinafter, a base station based method of searching small cells for configuring dual connectivity will be explained.

When a small cell is located within coverage of a macro cell, it is not easy for a terminal to search the small cell. For example, if a frequency used by the small cell is different from a frequency used by the macro cell, the possibility that the terminal omits searching the small cell is high. Also, if channel state of the macro cell is good, the terminal does not search the small cell so that it may be difficult to identity whether the small cell exists or not and to offload loads of the macro cell to the small cell.

In order to resolve the above-described problem, the present invention provides a method for searching small cells efficiently. The method for searching small cell, which will be explained in the following descriptions, may be performed as included in the method for managing inter-site CA illustrated in FIG. 5.

First, the macro base station transfers information to be used for searching small cells (for example, operating frequency of at least one small cell, bandwidth of at least one small cell, transmission power of at least one small cell, searching period, searching time, etc.) to the terminal. Here, transferring the information to be used for searching small cells may be performed as identical to the step S503 of FIG. 5, and may be performed prior to the step S503.

If the terminal receives the information to be used for searching small cells from the macro base station, the terminal performs preparation for searching small cells. However, in order to reduce power consumption, the terminal does not start searching small cell in this stage.

The macro base station instructs the terminal connected to the macro base station to search small cells so as to make the terminal search small cells. Specifically, if the macro base station determines that the number of terminals connected to the macro cell is large and load of the macro cell can be reduced by offloading some of the terminals to the small cell, the macro cell may instruct the terminal to search small cells. The instruction to search small cells may be transmitted to each of the terminals by using a downlink message or by using a paging channel. Also, the macro base station can indicate a specific terminal and instruct the specific terminal to search small cells, or can instruct all terminals existing within the macro cell to search small cells. Here, the instruction to search small cells may be performed between the step S504 and the step 505 of FIG. 5.

If the terminal receives the message instructing to search small cells from the macro base station, the terminal starts searching small cells according to preconfigured conditions.

Then, the terminal performs measurements on signals transmitted from the searched small cells, and reports measurement information to the macro base station. Here, the small cell search and the measurement report may be performed identically to the step S505 of FIG. 5.

If the macro base station receives the measurement report from the terminal, the macro base station performs a dual connectivity configuration procedure or a handover procedure for offloading the terminal to the small cell based on the received measurement report. For example, when channel state of the small cell is equal to or better than a threshold value, the macro base station may instruct the terminal to perform dual connectivity with the corresponding small cell or to perform handover to the corresponding small cell. The macro base station may instruct the terminal to perform additional measurement in order to obtain more accurate information of the small cell.

Hereinafter, a method for simplifying handover procedure in an environment to which dual connectivity is applied will be explained.

An objective of deploying small cells with a macro cell is offloading load of the macro cell or extending service coverage. In a case of offloading, small cells are deployed so that coverages of the small cells are overlapped with coverage of the macro cell. The present invention provides a method for simplifying handover procedures by using the above-described feature.

First, the macro base station may store information about terminals connected to the small cell. For example, if a terminal connects to the small cell, the macro base station receives information such as a terminal identifier, a terminal context, etc. from the small cell, and stores the information. Or, when a terminal moves from the macro cell to the small cell, the macro base station may store information about the terminal. The information is stored to be used again when the terminal moves from the small cell to the macro cell.

On the other hand, the small cell base station transmits configuration information of the small cell to the terminal. The small cell base station may transmit the configuration information of the small cell when the terminal connects to the small cell, or broadcast the configuration information by a broadcast channel. The configuration information may include information for offloading (when the small cell is located within coverage of the macro cell), coverage information (when a part of coverage of the small cell is overlapped with coverage of the macro cell), and inter-frequency/intra-frequency information (information about frequencies used for the small cell and the macro cell).

If a terminal moves or a channel state of the small cell becomes worse, the terminal performs handover to a neighbor cell. Here, in the case of small cells deployed for offloading, the terminal can perform handover to the macro cell. If the terminal performs handover from the small cell to the macro cell, since information about the terminal has been already stored in the macro base station, the terminal can connect to the macro cell immediately. Also, the small cell base station or the macro base station requests the terminal to perform handover so as to make the terminal connect to the macro cell immediately.

Hereinafter, a procedure for discontinuous reception (DRX) in the environment to which dual connectivity is applied will be explained.

When a terminal is dually connected to a macro cell and a small cell, since the terminal is controlled by the two cells, it is difficult to apply DRX for reducing power consumption. For example, if a first cell starts to transmit data to the terminal when the terminal performs DRX for a second cell, the terminal should be switched into a state that the terminal can receive data from the first cell so that power consumption cannot be reduced. In order to resolve the above-described problem, the present invention provides a method for the terminal to perform DRX efficiently by making the terminal interwork with the two cells to which the terminal is dually connected.

First, when the macro base station and the small cell base station configure dual connectivity with the terminal, they configure parameters related to DRX of the terminal. Specifically, the macro base station or the small cell may configure DRX for a carrier used by each cell, and may configure a message including the parameters to the terminal. In this case, the DRX parameters may be configured so that more data is transmitted through carriers of a cell having better channel state than the other cell. For example, when the channel state of the small cell is better or the amount of the data to be transmitted is large, the DRX period for the small cell may be configured to a relatively shorter value, and DRX period for the macro cell may be set to be multiples of the DRX period of the small cell (for example, one time (1×), two times (2×) or four times (4×) of the DRX period for the small cell, etc.).

The terminal configures its DRX period according to the DRX information received from the macro base station or the small cell base station, and receives downlink channels from each cell (for example, PDCCH) in accordance with the configured DRX period. Here, if channels are not received from all the cells, the terminal can check whether data exists or not by receiving downlink channels of the two cells located in the same subframe according to the DRX periods of the two cells.

The macro base station and/or the small cell base station may transmit data by using subframes corresponding to wakeup time of the terminal according to their DRX periods, and the terminal may receive the data according to the DRX periods. The terminal may receive data according to an instruction of the base station. Also, even if only one cell is configured to wake in an arbitrary subframe, the terminal can make all the cells wake so as to transmit or receive data. If the terminal wakes up according to the configured DRX period and finds a subframe through which the base station transmits data, the terminal can extend its wakeup time for a preconfigured amount of time so as to receive the data.

The terminal transmits, through uplink, an acknowledgement for the data received through downlink.

According to the above-described method for configuring dual connectivity, in an environment that a macro cell is overlapped with a small cell, in order for a terminal to configure multiple connections with a plurality of cells, a method for configuring dual connectivity using a manner expanding hand-over procedure, a method for configuring dual connectivity using a manner expanding carrier aggregation procedures, and a method for configuring dual connectivity using a manner expanding RRC connection procedures are provided. Therefore, dual connectivity can be configured efficiently according to a given network environment or mobility of the terminal. Thereby, the mobility of the terminal may be guaranteed and system performance may be enhanced.

Also, in the present invention, a method for a terminal to search small cells is provided so as to make the terminal perform cell search efficiently.

Also, in the present invention, a method for performing hand-over procedures is provided. Thereby, when a handover is necessary according to movement of the terminal or change of channel environment in an environment in which dual connectivity is configured, the handover can be performed rapidly, and so service quality can be guaranteed.

Also, in the present invention, a method for discontinuous reception (DRX), which can be applied to the environment in which dual connectivity is configured, is provided so that power consumption can be reduced even when the terminal maintains the dual connectivity.

While the example embodiments of the present invention and their advantages have been described in detail, it should be understood that various changes, substitutions and alterations may be made herein without departing from the scope of the invention.

What is claimed is:

1. A method for configuring dual connectivity, performed in a base station, the method comprising:
receiving measurement information about a neighbor cell of a terminal from a terminal;
obtaining information for configuring dual connectivity from the terminal or the base station;
determining whether to configure dual connectivity or not based on the measurement information and the information for configuring dual connectivity; and
if the dual connectivity is to be configured, transmitting a message instructing to configure the dual connectivity to the terminal.

2. The method of claim 1, wherein the information for configuring dual connectivity includes at least one of buffer status information of the terminal or the macro base station, service quality information of at least one bearer, movement speed information of the terminal, information about signal strength of the macro cell or the small cell.

3. The method of claim 1, wherein, in the determining whether to configure dual connectivity, the terminal connects to both a macro cell and a small cell when a movement speed of the terminal belongs to a predetermined reference speed range, and the terminal connects to only the macro cell when the movement speed of the terminal is higher than the predetermined reference speed range, and the terminal connects to only the small cell when the movement speed of the terminal is lower than the predetermined reference speed range.

4. The method of claim 1, wherein the transmitting a message instructing to configure the dual connectivity further includes:
when the dual connectivity is determined to be configured, checking whether the neighbor cell which is a target of the measurement information supports dual connectivity; and
when the neighbor cell supports dual connectivity, transmitting a message instructing the terminal to configure the dual connectivity with the neighbor cell.

5. The method of claim 1, further comprising:
receiving, by the base station, terminal capability information from at least one terminal including the terminal; and
managing the at least one terminal based on the received terminal capability information,
wherein the terminal capability information includes information about at least one of whether to support dual connectivity, whether to be able to transmit uplink control channels in parallel, and whether to be able to receive downlink control channels in parallel.

6. The method of claim 1, further comprising:
managing, by the base station, connection information of at least one small cell,
wherein the connection information includes information about at least one of identifier of the at least one small cell, position of the at least one small cell, and transmission power of the at least one small cell.

7. The method of claim 1, further comprising, prior to the receiving measurement information, transmitting information for searching small cells to the terminal, wherein the information for searching small cells includes information about at least one of frequency of at least one target small cell, bandwidth of at least one target small cell, transmission power of at least one target small cell, cell search period, and cell search time.

8. The method of claim 7, further comprising, prior to the receiving measurement information, transmitting a message instructing to search small cells to the to terminal when a preconfigured small cell search condition is satisfied.

9. A method for configuring dual connectivity, performed in a base station, the method comprising:
determining whether to configure dual connectivity based on measurement information about a neighbor cell reported from a terminal;
if it is necessary to configure the dual connectivity, transmitting a message requesting preparation of dual connectivity to a small cell base station with which the terminal will establish a connection;
receiving an acknowledgement message for the message requesting preparation of dual connectivity from the small cell base station; and
transmitting a message instructing a start of the dual connectivity to the terminal.

10. The method of claim 9, wherein the message requesting preparation of dual connectivity includes information about at least one of a terminal context of the terminal, a Cell Radio Network Temporary Identifier (C-RNTI) of the terminal, and at least one bearer to be used for dual connectivity.

11. The method of claim 9, wherein the acknowledgement message includes information about at least one of a physical layer of the small cell base station, resources of the small cell base station, a Cell Radio Network Temporary Identifier (C-RNTI) of the terminal, and a random access channel.

12. The method of claim 9, wherein the message instructing a start of the dual connectivity is transmitted by using a RRC message, and the message instructing a start of the dual connectivity includes at least one of mobility control information, a dual connectivity indicator, information about a physical layer of the small cell base station, system information, information about at least one bearer, information about a random access channel, a Cell Radio Network Temporary Identifier (C-RNTI) information of the terminal.

13. The method of claim 9, further comprising managing at least one bearer for the dual connectivity by the base station.

14. The method of claim 13, wherein, in the managing at least one bearer for the dual connectivity, whether a related bearer is transmitted or not is determined according to a channel state of the macro cell or the small cell, or information about the related bearer is transmitted to the small cell base station, or data is forwarded to the small cell base station.

15. A method for configuring dual connectivity, performed in a base station, the method comprising:
determining whether to configure dual connectivity based on measurement information about a neighbor cell reported from a terminal;
if it is necessary to configure the dual connectivity, transmitting a message instructing addition of a secondary cell (SCell) to a small cell base station;
receiving an acknowledgement message for the message requesting instructing addition of a secondary cell (SCell) from the small cell base station; and
transmitting a message instructing a start of the dual connectivity to the terminal.

16. The method of claim 15, wherein the message instructing addition of a secondary cell (SCell) includes at least one of a terminal context information of the terminal, a Cell Radio Network Temporary Identifier (C-RNTI) of the terminal, and information about at least one bearer to be used for dual connectivity.

17. The method of claim 15, wherein the acknowledgement message includes information about at least one of a physical layer of the small cell base station, resources of the small cell base station, a Cell Radio Network Temporary Identifier (C-RNTI) of the terminal, and a random access channel.

18. The method of claim 15, wherein the message instructing a start of the dual connectivity is transmitted by using a RRC message, and the message instructing a start of the dual connectivity includes at least one of information about parameters related to the addition of a SCell, an indication of non-ideal backhaul, a physical layer of the small cell base station, system information, information about at least one bearer, random access channel information, and a Cell Radio Network Temporary Identifier (C-RNTI) of the terminal.

19. The method of claim 15, further comprising transmitting a downlink control channel including information indicating a carrier to the terminal.
